(19) United States
(12) Patent Application Publication
(10) Pub. No.: US 2018/0202214 A1
(43) Pub. Date: Jul. 19, 2018

(54) PINCHING DETECTION DEVICE

(71) Applicant: KABUSHIKI KAISHA TOKAI RIKA DENKI SEISAKUSHO, Aichi (JP)

(72) Inventor: Tatsushi KATSUYAMA, Aichi (JP)

(73) Assignee: KABUSHIKI KAISHA TOKAI RIKA DENKI SEISAKUSHO, Aichi (JP)

(21) Appl. No.: 15/743,730

(22) PCT Filed: Jul. 14, 2016
(86) PCT No.: PCT/JP2016/070834

§ 371 Date: Jan. 11, 2018

(30) Foreign Application Priority Data
Aug. 4, 2015 (JP) 2015-153902

(51) Int. Cl. E05F 15/46; E05F 15/695; B60J 1/17

(52) U.S. Cl. CPC E05F 15/46; E05F 15/695; E05Y 2201/434; E05Y 2900/55; E05Y 2900/531; B60J 1/17

(57) ABSTRACT

An entrapment detection device, which detects entrapment caused by an opening/closing movement of an opening/closing body, includes a looped sensor electrode arranged on the opening/closing body. The entrapment detection device further includes a detection unit that detects entrapment between the opening/closing body and an external member based on a change in capacitance of the looped sensor electrode.

### TECHNICAL FIELD

The present invention relates to an entrapment detection device.

### BACKGROUND ART

Patent document 1 discloses an entrapment detection device including an electrode that configures part of an electrostatic sensor and is arranged on a door window, which is one example of an opening/closing body. The entrapment detection device uses the electrostatic sensor to detect entrapment. When the electrostatic sensor detects entrapment as the door window closes, the movement of the door window is reversed. This releases an entrapped subject from the door window.

### PRIOR ART DOCUMENT

Patent Document 1: Japanese Laid-Open Patent Publication No. 2005-314949

### SUMMARY OF THE INVENTION

### Problems that are to be Solved by the Invention

In Patent Document 1, the electrode is arranged along an upper edge of the door window. In this configuration, the electrode is exposed to the outside. Thus, a portion of the electrode may be broken due to deterioration or the like resulting from weathering or wear resulting from contact between the electrode and a glass run when the window is closed. In such a case, a detection unit, which detects entrapment, cannot detect entrapment at the electrode portion that is disconnected from the detection unit, which detects entrapment. Therefore, the durability of the entrapment detection device is insufficient.

It is an object of the present invention to provide an entrapment detection device having high durability.

### Means for Solving the Problem

According to one aspect, an entrapment detection device that detects entrapment caused by an opening/closing movement of an opening/closing body is provided. The entrapment detection device includes a looped sensor electrode arranged on the opening/closing body and a detection unit that detects entrapment between the opening/closing body and an external member based on a change in capacitance of the looped sensor electrode.

In this configuration, the sensor electrode is looped. Thus, even if part of the sensor electrode is broken, a closed circuit is formed with the sensor electrode when an entrapment subject approaches or contacts the sensor electrode. This is because a flow path for current is obtained between the broken portion of the sensor electrode and the detection unit regardless of the location of breakage. Therefore, even if part of the sensor electrode is broken, the detection unit is able to detect whether or not entrapment has occurred. More specifically, even if part of the sensor electrode is broken, the sensor electrode can be used as usual, thereby improving the durability of the entrapment detection device.

### Effect of the Invention

The present invention allows for improvement of the durability of the entrapment detection device.

### BRIEF DESCRIPTION OF THE DRAWINGS

FIG. 1 is a schematic view illustrating an entrapment detection device applied to a power window.

FIG. 2 is a schematic view illustrating a power window, indicating a flow of current when a sensor electrode breaks.

FIG. 3 is a schematic view illustrating a power window according to another embodiment.

FIG. 4 is a schematic view illustrating a sensor electrode according to a further embodiment including an enlarged cross-sectional view of and around the sensor electrode.

### EMBODIMENTS OF THE INVENTION

One embodiment of an entrapment detection device will now be described. The entrapment detection device of the present example is applied to a vehicle power window, which is one example of an opening/closing controller.

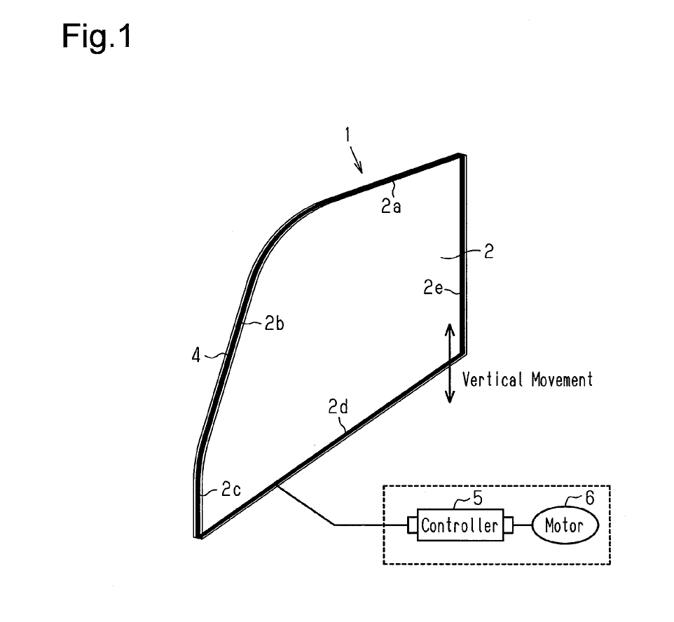

As illustrated in FIG. 1, a power window 1 includes a window glass 2, a sensor electrode 4, a controller 5, and a motor 6.

The window glass 2 corresponds to an opening/closing body and is driven by the motor 6 to move in the vertical direction while sliding in a window frame (external member, not illustrated). The opening movement of the window glass 2 is defined by a lowering movement of the window glass 2, and the closing movement of the window glass 2 is defined by a lifting movement of the window glass 2.

A sensor electrode 4 is arranged in a looped manner entirely on the peripheral edges, or end surface, of the plate-like window glass 2. The end surfaces of the window glass 2, on which the sensor electrode 4 is arranged, correspond to peripheral surfaces of the window glass 2 that are continuous in a looped manner and are orthogonal to a direction in which the window glass 2 opens/closes (vertical direction in this example).

The controller 5 is electrically connected to the sensor electrode 4, the motor 6, and an operation switch (not illustrated) that undergoes an operation input for starting the opening or closing movement of the window glass 2. The controller 5 corresponds to the detection unit.

When acknowledging an operation input to the operation switch, the controller 5 drives the motor 6 to open or close the window glass 2.

The opening operation and the closing operation of the window glass 2 each include a manual operation that stops movement of the window glass 2 when the operation switch is released and an automatic operation that continues movement of the window glass 2 until the window glass 2 reaches a fully-open position or a fully-closed position even if the operation switch is released. In the automatic operation, an operation for continuing the lowering movement of the window glass 2 until the window glass 2 reaches the fully-open position is referred to as the “automatic down operation,” and an operation for continuing a lifting movement of the window glass 2 until the window glass 2 reaches the fully-closed position is referred to as the “automatic up operation.”

The controller 5 constantly monitors changes in capacitance of the sensor electrode 4. For example, when the controller 5 detects an increase in capacitance of the sensor electrode 4 during a lifting movement of the window glass 2 that is started by an automatic up operation, the controller 5 reverses movement of the window glass 2, that is, lowers the window glass 2. This releases an entrapped subject such as a finger from the window glass 2.

### Operation

The operation of the power window 1 will now be described. In the known art, when an electrode (sensor electrode 4 in this embodiment) and an entrapment subject such as a finger approach each other, a capacitor, in which the entrapment subject and the sensor electrode 4 function as an electrode, is connected to ground to form a closed circuit so that current flows to the sensor electrode 4. This will not be described in detail. Contact of an entrapment subject with the sensor electrode 4 also forms a closed circuit similar to that described above so that current flows to the sensor electrode 4.

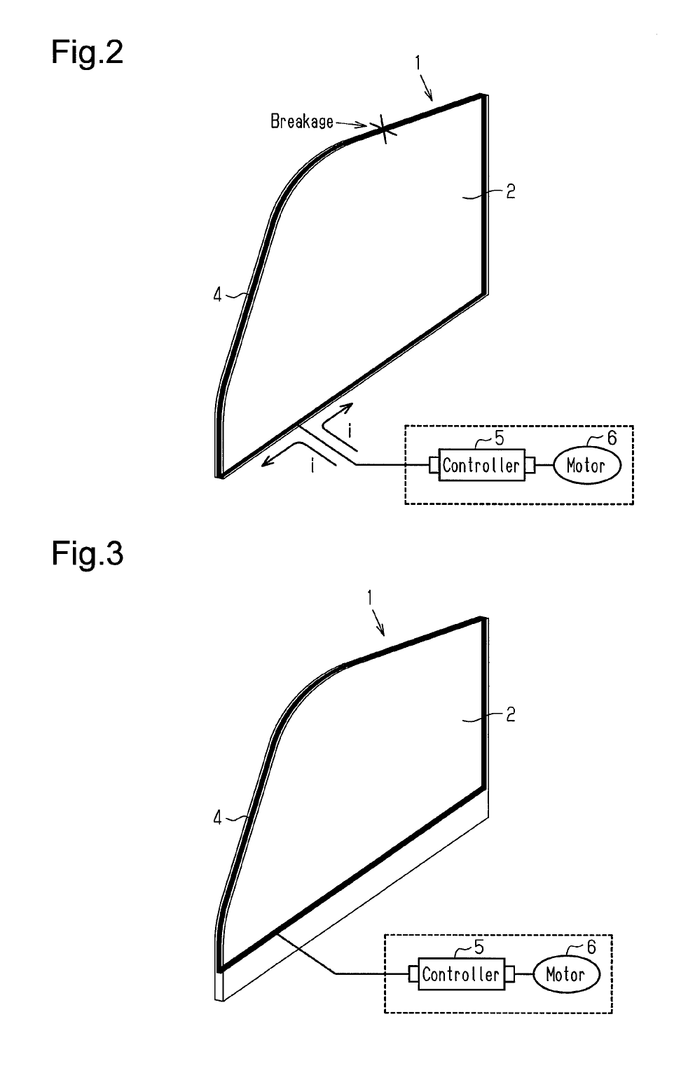

The sensor electrode 4 is arranged in a looped manner entirely on the periphery of the window glass 2, or the end surfaces of the window glass 2. As illustrated in FIG. 2, this allows current to flow clockwise and counterclockwise through the sensor electrode 4 in the circumferential direction of the window glass 2.

The sensor electrode 4, which is arranged on the window glass 2, slides along the window frame and exposed to the ambient climate. Therefore, the sensor electrode 4 may be partially broken. A case regarding the location marked by a cross in FIG. 2 will now be described. In this case, current flowing in one direction (e.g., counterclockwise direction in FIG. 2) is supplied to a portion of the sensor electrode 4 on the right side of the cross, and current flowing in the other direction (e.g., clockwise direction in FIG. 2) is supplied to a portion of the sensor electrode 4 on the left side of the cross. Therefore, even if the sensor electrode 4 is broken, the controller 5 remains conductive throughout regardless of where the breakage is located.

As described above, the present embodiment has the following advantages.

(1) The sensor electrode 4 is looped. Therefore, even when part of the sensor electrode 4 is broken, a closed circuit would be formed with ground if a subject approaches or contacts the sensor electrode 4. This is because a path is obtained for the flow of current toward the broken location in one direction of the loop (clockwise direction in this example) and the other direction of the loop (counterclockwise direction in this example). Therefore, even if part of the sensor electrode 4 is broken, the controller 5 is able to detect whether or not an entrapment has occurred. This easily resolves a state in which an entrapment subject is entrapped between the window glass 2 and the window frame.

Thus, even if part of the sensor electrode 4 is broken, the sensor electrode 4 can be used as usual. This improves the durability of the power window 1 having a function for detecting entrapment.

(2) The sensor electrode 4 is arranged in a looped manner entirely over the peripheral surface of the window glass 2, or the outer edges, which are the end surfaces, of the window glass 2, that is looped in a continuous manner and orthogonal to a direction in which the window glass 2 opens/closes (a vertical direction in this example). This allows the sensor electrode 4 to be arranged on the window glass 2 without being twisted and reduces costs for manufacturing the sensor electrode 4 and attaching the sensor electrode 4 to the window glass 2.

(3) The sensor electrode 4 is arranged on the end surfaces of the window glass 2. This ensures the field of view through the window glass 2 without affecting the aesthetic appeal.

The above embodiment may be modified as described below.

In the above embodiment, the sensor electrode 4 is looped and arranged entirely on the outer edges of the window glass 2 that correspond to the end surfaces of the window glass 2. However, as illustrated in FIG. 3, the sensor electrode 4 can be partially arranged on the plate surface (i.e., a surface differing from end surfaces) of the window glass 2. This arrangement obtains advantage (1) of the above embodiment.

It is preferred that the sensor electrode 4 be arranged on at least the edge of the window glass 2 located in the closing direction. As illustrated in FIG. 1, an upper end surface 2a and an inclined end surface 2b of the window glass 2 correspond to the outer edges of the window glass 2 in this example.

Referring to FIG. 1, the above embodiment detects an entrapment subject with the portion of the sensor electrode 4 arranged on the upper end surface 2a of the window glass 2 and the inclined end surface 2b of the window glass 2 that is continuous with the front side of the upper end surface 2a. In other words, the portion of the sensor electrode 4 arranged on a front end surface 2c that is continuous with the front side of the inclined end surface 2b of the window glass 2, a lower end surface 2d that is continuous with the front end surface 2c, and a rear end surface 2e that is continuous with the lower end surface 2d and the upper end surface 2a are not exposed to the outside since they are constantly accommodated in the window frame (not illustrated) or inside a door (not illustrated) and thus do not contact an entrapment subject. In this example, the upper end surface 2a and the inclined end surface 2b of the window glass 2 correspond to a first portion (portion where entrapment may occur) of the window glass 2 (opening/closing body). Further, the front end surface 2c, the lower end surface 2d, and the rear end surface 2e of the window glass 2 correspond to a second portion (part that differs from first portion) of the window glass 2.

In this case, it is preferred that the portion that does not detect an entrapment subject, in the present example, the portion of the sensor electrode 4 arranged on the front end surface 2c, the lower end surface 2d, and the rear end surface 2e of the window glass 2, be electrically shielded so as not to form a capacitor of which the electrode is the window frame (not illustrated) or the inside of the door (not illustrated).

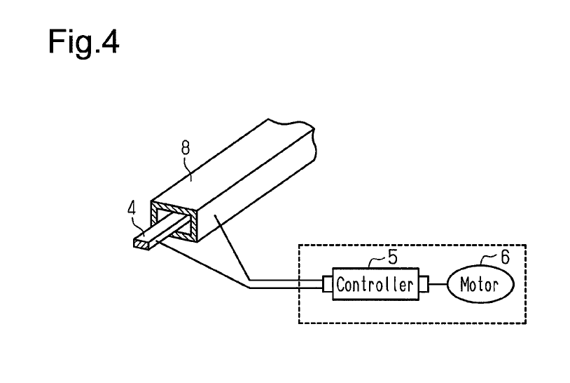

For example, as illustrated in FIG. 4, a hollow shield electrode 8 may be arranged on the front end surface 2c, the lower end surface 2d, and the rear end surface 2e of the window glass 2. The sensor electrode 4 extends through the hollow shield electrode 8 so that the sensor electrode 4 does not contact the inner surface of the shield electrode 8. The controller 5 is electrically connected to the shield electrode 8. The controller 5 applies voltage so that the potential at the sensor electrode 4 is the same as that at the shield electrode 8. The gap between the sensor electrode 4 and the shield electrode 8 may be open space (air) or be filled with a nonconductive member. The shield electrode 8 is one example of the hollow conductive member and does not have to be shaped as illustrated in FIG. 4.

In this configuration, the potential is the same at the sensor electrode 4 and the shield electrode 8. Thus, a difference in capacitance does not occur between the sensor electrode 4 and the shield electrode 8, and a capacitor is not formed in the portion where the shield electrode 8 is arranged. In other words, the formation of a capacitor that allows for the detection of an entrapment subject occurs only at the portion of the sensor electrode 4 that is not provided with the shield electrode 8, namely, the portion of the sensor electrode 4 arranged on the upper end surface 2a and the inclined end surface 2b of the window glass 2.

Therefore, the area of the portion of the electrode where a capacitor can be formed is the same for a case where the portion of the sensor electrode 4 arranged on the front end surface 2c, the lower end surface 2d, and the rear end surface 2e of the window glass 2 is electrically shielded and a case where an electrode (non-looped electrode) is provided only on the upper end surface 2a and the inclined end surface 2b of the window glass 2. Therefore, the controller 5 does not to have to change the determination reference value (threshold value) for determining whether or not entrapment has occurred from the conventional reference value. That is, the power window 1 can be used by merely replacing a conventional window glass of a vehicle with the window glass 2 including the sensor electrode 4 and the shield electrode 8 and without the need to reset the controller 5.

In the above embodiment, when the controller 5 detects an increase in capacitance of the sensor electrode 4 during the lifting movement of the window glass 2 started by an automatic up operation, the controller 5 lowers the window glass 2 to release an entrapped subject. The lowering movement is not limited to cases in which the lifting movement of the window glass 2 is started as an automatic up operation. For example, the controller 5 can lower the window glass 2 to release an entrapped subject when detecting an increase in the capacitance of the sensor electrode 4 during a lifting movement of the window glass 2 started as a manual operation.

Further, the window glass 2 does not necessarily have to be lowered. That is, the controller 5 may be configured to stop the lifting movement of the window glass 2 regardless of whether it is an automatic operation or a manual operation if an increase in the capacitance of the sensor electrode 4 is detected during the lifting movement of the window glass 2. This prevents the entrapped subject from being caught in the window glass 2.

In the above embodiment, the sensor electrode 4 need only be a conductive material.

In the above embodiment, the entrapment detection device is applied to the power window 1 in which the window glass 2 of the vehicle serves as the opening/closing body. The entrapment detection device may also be applied to opening/closing bodies such as those that will now be described. The opening/closing body may be a shutter or the like of a building in which an opening movement is defined by a lifting movement and a closing movement is defined by a lowering movement. Further, the opening/closing body may be a swinging door in which the opening/closing movement is defined by a swinging movement. The opening/closing body may also be a sliding door of a vehicle or an automatic door of a building in which the opening/closing movement is defined by movement in a horizontal direction.

1. An entrapment detection device that detects entrapment caused by an opening/closing movement of an opening/closing body, the entrapment detection device comprising:
a looped sensor electrode arranged on the opening/closing body; and
a detection unit that detects entrapment between the opening/closing body and an external member based on a change in capacitance of the looped sensor electrode.

2. The entrapment detection device according to claim 1, wherein
the opening/closing body includes a peripheral surface that is continuous in a looped manner and orthogonal to a direction in which the opening/closing body opens/closes, and
the looped sensor electrode is arranged in a looped manner along the peripheral surface.

3. The entrapment detection device according to claim 1, further comprising a hollow conductive member, wherein
the opening/closing body includes a first portion that may cause entrapment with the external member and a second portion that differs from the first portion,
the looped sensor electrode is arranged on both of the first portion and the second portion,
a portion of the looped sensor electrode that is arranged on the second portion extends through the hollow conductive member without contacting the hollow conductive member, and
a same voltage is applied to both of the hollow conductive member and the looped sensor electrode.
